(19) United States
(12) Patent Application Publication
(10) Pub. No.: US 2024/0070719 A1
(43) Pub. Date: Feb. 29, 2024

(54) INFORMATION PROCESSING METHOD

(71) Applicant: TOYOTA JIDOSHA KABUSHIKI KAISHA, Aichi-ken (JP)

(72) Inventors: Takahiro AOKI, Saitama-shi (JP); Tsuyoshi WATANABE, Saitama-shi (JP)

(21) Appl. No.: 18/457,343

(22) Filed: Aug. 29, 2023

(30) Foreign Application Priority Data
Aug. 30, 2022 (JP) 2022-137279

(51) Int. Cl. G06Q 30/0251

(52) U.S. Cl. CPC G06Q 30/0265; G06Q 30/0255

(57) ABSTRACT

A method performed by a server, the method includes acquiring a boarding condition for a user who uses a vehicle as transportation, the boarding condition including a departure location, a destination location, and/or a utilization time of travel using the vehicle, selecting one or more second services meeting the boarding condition from among a plurality of first services, the plurality of first services being services related to sales and/or marketing capable of being provided in the vehicle during the travel, and outputting an inquiry notification including information regarding the second services to an in-vehicle apparatus of the vehicle and/or a terminal of the user, in order to allow the user to respond whether to accept provision of at least any one of the selected second services when the user uses the vehicle under the boarding condition.

### CROSS-REFERENCE TO RELATED APPLICATION

This application claims priority to Japanese Patent Application No. 2022-137279, filed on Aug. 30, 2022, the entire contents of which are incorporated herein by reference.

### TECHNICAL FIELD

The present disclosure relates to an information processing method.

### BACKGROUND

Systems that support online business meetings between customers and sales representatives via computer networks such as the Internet are proposed. For example, a business meeting support apparatus disclosed in Patent Literature (PTL) 1 sets up an online meeting in response to a request by a sales representative from a terminal apparatus. Furthermore, a connection code to connect to the online meeting is generated in response to a request by a customer from a customer terminal, and the connection code is linked to the online meeting.

### CITATION LIST

### Patent Literature

PTL 1: JP 2022-049606 A

### SUMMARY

Conventional methods for providing services (hereinafter also referred to as “sales services”) related to sales and/or marketing have room for improvement in providing services to potential customers (service recipients) who are not being actively engaged in receiving services.

It would be helpful to improve technology for providing sales services.

A method according to an embodiment of the present disclosure is an information processing method performed by a server, the information processing method including:
acquiring a boarding condition for a user who uses a vehicle as transportation, the boarding condition including a departure location, a destination location, and/or a utilization time of travel using the vehicle;
selecting one or more second services meeting the boarding condition from among a plurality of first services, the plurality of first services being services related to sales and/or marketing capable of being provided in the vehicle during the travel; and
outputting an inquiry notification including information regarding the second services to an in-vehicle apparatus of the vehicle and/or a terminal of the user, in order to allow the user to respond whether to accept provision of at least any one of the selected second services when the user uses the vehicle under the boarding condition.

A server according to an embodiment of the present disclosure includes a processor configured to:
acquire a boarding condition for a user who uses a vehicle as transportation, the boarding condition including a departure location, a destination location, and/or a utilization time of travel using the vehicle;
select one or more second services meeting the boarding condition from among a plurality of first services, the plurality of first services being services related to sales and/or marketing capable of being provided in the vehicle during the travel; and
output an inquiry notification including information regarding the second services to an in-vehicle apparatus of the vehicle and/or a terminal of the user, in order to allow the user to respond whether to accept provision of at least any one of the selected second services when the user uses the vehicle under the boarding condition.

According to the present disclosure, technology for providing sales services can be improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of each of first to third servers;

FIG. 3 is a block diagram illustrating a schematic configuration of each of an in-vehicle apparatus, user terminal, and sales terminal;

FIG. 4 is a sequence diagram illustrating an example of processes for providing sales services;

FIG. 5 is a flowchart illustrating an example of operations of the first server; and

FIG. 6 is a sequence diagram illustrating another example of processes for providing sales services.

### DETAILED DESCRIPTION

An embodiment of the present disclosure will be described below, with reference to the drawings.

(Overall Configuration)

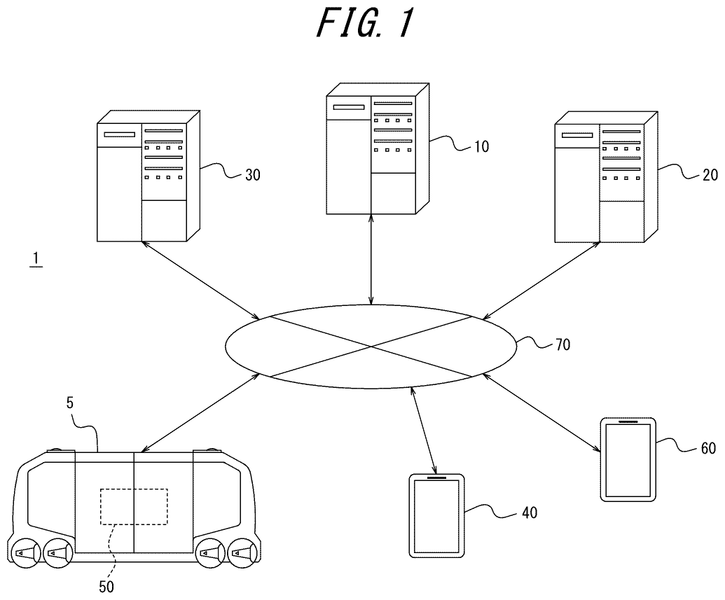

As illustrated in FIG. 1, a system 1 according to an embodiment of the present disclosure includes a first server 10, a second server 20, a third server 30, a user terminal 40, a vehicle 5 and an in-vehicle apparatus 50 mounted thereon, and a sales terminal 60. The above components of the system 1 are configured to be communicable with each other via a network 70 including, for example, the Internet and a mobile communication network.

For simplicity of explanation, FIG. 1 illustrates one each of the components provided in the system 1, but the number of the components is not limited to this. Each component may be two or more. The functions of each of the first server 10, second server 20, and third server 30 may be distributed across multiple pieces of hardware. The functions provided by the first server 10, second server 20, and third server 30 may be consolidated in any combination into one or two pieces of hardware.

The first server 10, second server 20, and third server 30 are computers including dedicated server machines, personal computers (PCs), or the like. The first server 10 can match a plurality of sales services provided by a plurality of second servers 20 with a plurality of users who requests travel using the vehicle 5 to a plurality of third servers 30.

The second server 20 is a server of a sales service provider that provides sales services to users. The sales services are services related to sales and/or marketing. In the present disclosure, the sales services include sales-related services (sales services in the narrow sense) and marketing services. The sales-related services include providing explanation of products and conducting business meetings with users, either online or in person. The products include, for example, insurance products, real estates, travel products, and the like. The marketing services include conducting questionnaires, testing samples, and marketing researches. The marketing researches include, for example, those that examine a success rate of business meetings with music or aromas. For the provider of the sales services (in the broad sense), benefits exist in providing such sales services to users. For this reason, the provider of the sales services provides the users with benefits including reduction of a fee related to the travel, provision of compensation, and/or the like, along with provision of the sales services.

The third server 30 is a server of a transportation service provider that provides transportation services to users. The transportation service provider includes, for example, transportation operators, transportation application providers, and car rental companies. The transportation services include transportation services provided on demand by taxicabs. The transportation application providers include providers of applications that mediate ridesharing services. The transportation service provider further includes providers that offer trip planning services for users who travel using private vehicles. The vehicle 5 includes vehicles provided by the transportation service provider for use by users, as well as private vehicles of users who use the services of the transportation service provider.

In the following description of the embodiment, the vehicle 5 is a vehicle for transportation services provided on demand. The vehicle 5 is an automobile, for example, but is not limited to this and may be any vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 5 may be a manned vehicle or any autonomous vehicle that travels unmanned.

Assume that users who receive sales services are not driving manually. When the vehicle 5 is an autonomous vehicle, users on board the vehicle 5 can receive sales services. When not driving manually, users on board the vehicle often have no plans to do anything during time of travel. In other words, the users during travel may have spare time. The system 1 provides sales services for this spare time of the users during travel in exchange for reduction or no charge for a fee related to the travel, or some form of compensation.

The general online provision of sales services targets users who are actively accessing information on certain products or services. Such users are actively browsing the products or services, so it is easy for service providers to provide information. On the other hand, potential users who are not actively seeking the provision of services do not necessarily actively browse information on the products or services. Therefore, it is not easy for service providers to conduct sales or marketing to these potential users. Even if the service provides try to provide sales services to such users, the users may not accept or may ignore service offerings because of lack of willingness to acquire information. However, users on board the vehicle 5 during travel may have time (spare time) during the travel and may browse information of relatively low interest. Therefore, it can be expected that the users are more likely to accept the provision of services for the spare time.

The user terminal 40 is any electronic apparatus in the possession of a user. The user terminal 40 may be, but is not limited to, a portable information terminal. For example, a general purpose or dedicated electronic device such as a smartphone, tablet, or PC can be used as the user terminal 40. The user terminal 40 may be not a terminal of a user who applies for a transportation service but a terminal of a passenger on board the same vehicle 5.

The in-vehicle apparatus 50 is an electronic apparatus mounted in the vehicle 5. The in-vehicle apparatus 50 can be linked to various parts of the vehicle 5. For example, the in-vehicle apparatus 50 can set a travel route according to a user's request. The in-vehicle apparatus 50 can also provide information to a user on board the vehicle 5 and receive input from the user on board the vehicle 5. A plurality of in-vehicle apparatuses 50 may be arranged in the vehicle 5 to accommodate the number of passengers allowed in the vehicle 5.

The sales terminal 60 is a terminal apparatus in the possession of a sales representative of a particular sales service. The sales terminal 60 can receive information to be advertised from the second server 20, instructions to board the vehicle 5, an electronic key that is electronic information to unlock the vehicle 5, and the like. The sales terminal 60 is an electronic device similar to the user terminal 40.

(Configuration of First, Second, and Third Servers)

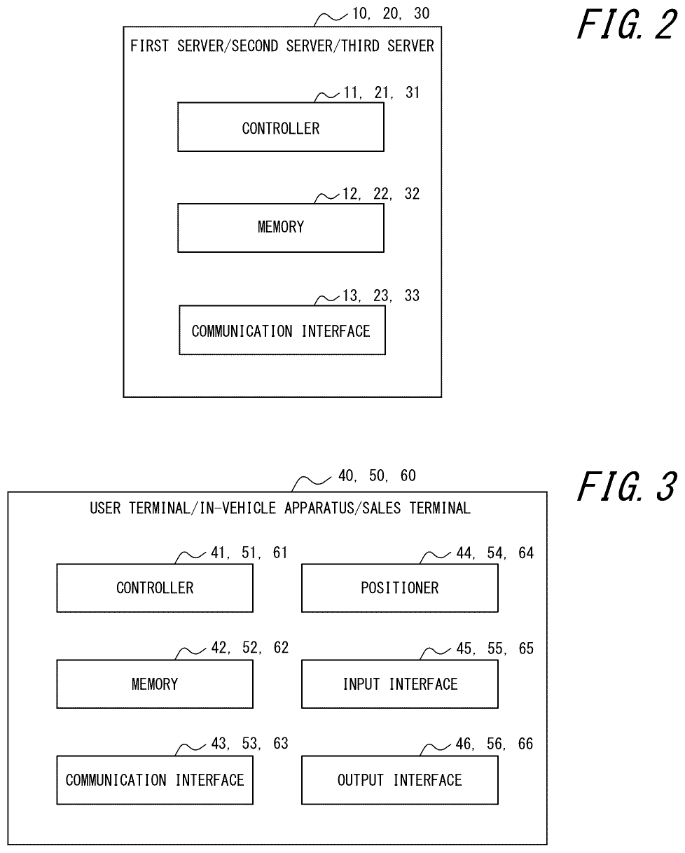

The first server 10 includes a controller 11, a memory 12, and a communication interface 13. The second server 20 includes a controller 21, a memory 22, and a communication interface 23. The third server 30 includes a controller 31, a memory 32, and a communication interface 33. The first, second, and third servers 10, 20, and 30 are similar in configuration and will be described together below using the same drawing, FIG. 2.

The controllers 11, 21, and 31 each include at least one processor, at least one dedicated circuit, or a combination thereof. Examples of the processor include a general purpose processor such as a central processing unit (CPU) and a dedicated processor dedicated to specific processing. The controller 11 executes processes related to operations of the first server 10 while controlling components of the first server 10. The controllers 21 and 31 also perform similar processes for the second and third servers 20 and 30, respectively. In the following description, processes performed by the controllers 11, 21, and 31 may be described as those performed by the first, second, and third servers 10, 20, and 30, respectively. Processes performed by the first, second, and third servers 10, 20, and 30 can be referred to as processes performed by the controllers 11, 21, and 31, respectively.

The memories 12, 22, and 32 each include at least one semiconductor memory, at least one magnetic memory, at least one optical memory, or a combination of at least two of these. The memories 12, 22, and 32 each function as, for example, a main memory, an auxiliary memory, or a cache memory. The memory 12 stores programs and data to be used for the operations of the first server 10 and data obtained by the operations of the first server 10. The memories 22 and 32 also function similarly for the second and third servers 20 and 30, respectively. The information stored in the memories 12, 22, and 32 may be updated with, for example, information acquired from the network 70 via the communication interfaces 13, 23, and 33, respectively.

The communication interfaces 13, 23, and 33 each include at least one interface for external communication for connecting to the network 70. The interface for communication may be either a wired or wireless communication interface.

The first, second, and third servers 10, 20, and 30 in FIG. 2 of the present embodiment may each further include an input interface and output interface. In other words, in addition to receiving (input) and transmitting (output) information via the communication interfaces 13, 23, and 33, the first, second, and third servers 10, 20, and 30 may perform input and output of information via the input and output interfaces.

The functions of the first server 10 may be implemented by executing a program according to a method of the present disclosure by a processor corresponding to the controller 11. That is, the functions of the first server 10 are realized by software. The program causes a computer to execute the operations of the first server 10, thereby causing the computer to function as the first server 10. That is, the computer executes the operations of the first server 10 in accordance with the program to thereby function as the first server 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory.

(Configuration of User Terminal/in-Vehicle Apparatus/Sales Terminal)

As illustrated in FIG. 3, the user terminal 40, in-vehicle apparatus 50, and sales terminal 60 include controllers 41, 51, and 61, memories 42, 52, and 62, communication interfaces 43, 53, and 63, positioners 44, 54, and 64, input interfaces 45, 55, and 65, and output interfaces 46, 56, and 66, respectively. The components of the in-vehicle apparatus 50 may be at least partially distributed within the vehicle 5. The user terminal 40, in-vehicle apparatus 50, and sales terminal 60 are similar in configuration and will be described together below using the same drawing, FIG. 3.

The controllers 41, 51, and 61 each include at least one processor, at least one dedicated circuit, or a combination thereof. The controllers 41, 51, and 61 execute processes related to operations of the user terminal 40, in-vehicle apparatus 50, and sales terminal 60 while controlling components of the user terminal 40, in-vehicle apparatus 50, and sales terminal 60, respectively. In the following description, processes performed by the controllers 41, 51, and 61 may be described as those performed by the user terminal 40, in-vehicle apparatus 50, and sales terminal 60, respectively. Processes performed by the user terminal 40, in-vehicle apparatus 50, and sales terminal 60 can be referred to as processes performed by the controllers 41, 51, and 61, respectively.

The memories 42, 52, and 62 each include at least one semiconductor memory, at least one magnetic memory, at least one optical memory, or a combination of at least two of these. The memories 42, 52, and 62 store programs and data to be used for the operations of the user terminal 40, in-vehicle apparatus 50, and sales terminal 60, and data obtained by the operations of the user terminal 40, in-vehicle apparatus 50, and sales terminal 60, respectively. The information stored in the memories 42, 52, and 62 may be updated with, for example, information acquired from the network 70 via the communication interfaces 43, 53, and 63, respectively.

The communication interfaces 43, 53, and 63 each include at least one interface for external communication for connecting to the network 70. The communication interfaces 43, 53, and 63 receive data to be used for the operations of the user terminal 40, in-vehicle apparatus 50, and sales terminal 60, and transmit data obtained by the operations of the user terminal 40, in-vehicle apparatus 50, and sales terminal 60 to the outside, respectively. The communication interfaces 43, 53, and 63 may each have a communication interface for short-range wireless communication compliant with standards such as Near Field Communication (NFC), Bluetooth® (Bluetooth is a registered trademark in Japan, other countries, or both) Low Energy (BLE), and Infrared Data Association (IrDA).

The positioners 44, 54, and 64 each include one or more apparatuses that acquire location information on the user terminal 40, in-vehicle apparatus 50, and sales terminal 60, respectively. The location of the in-vehicle apparatus 50 corresponds with the location of the vehicle 5. The positioners 44, 54, and 64 each include a receiver corresponding to the Global Positioning System (GPS), for example, but is not limited to this, and may include a receiver corresponding to any satellite positioning system. The positioners 44, 54, and 64 may acquire the location information on the user terminal 40, in-vehicle apparatus 50, and sales terminal 60 continually, periodically, or non-periodically.

The input interfaces 45, 55, and 65 each include at least one interface for input. The interface for input is, for example, a physical key such as a keyboard, a capacitive key, a pointing device, or a touch screen integrally provided with a display. The interface for input may be, for example, a microphone that accepts audio input, a camera that accepts image input, or the like. The input interfaces 45, 55, and 65 may accept operation for inputting data to be used for the operations of the user terminal 40, in-vehicle apparatus 50, and sales terminal 60, respectively. The input interfaces 45, 55, and 65 may be connected to the user terminal 40, in-vehicle apparatus 50, and sales terminal 60 as external input devices, instead of being provided in the user terminal 40, in-vehicle apparatus 50, and sales terminal 60, respectively.

The output interfaces 46, 56, and 66 each include at least one interface for output. The interface for output is, for example, a display for outputting information in the form of an image, a speaker for outputting information in the form of audio, or the like. The display is, for example, an LCD or an organic EL display. The output interface 56 of the in-vehicle apparatus 50 may display and/or project information onto a window of the vehicle 5. The output interfaces 46, 56, and 66 output data received via the network 70, data obtained by the operations of the user terminal 40, in-vehicle apparatus 50, and sales terminal 60, or the like, respectively. The output interfaces 46, 56, and 66 may be connected to the user terminal 40, in-vehicle apparatus 50, and sales terminal 60 as external output devices, instead of being provided in the user terminal 40, in-vehicle apparatus 50, and sales terminal 60, respectively.

(Procedure for Providing Sales Service)

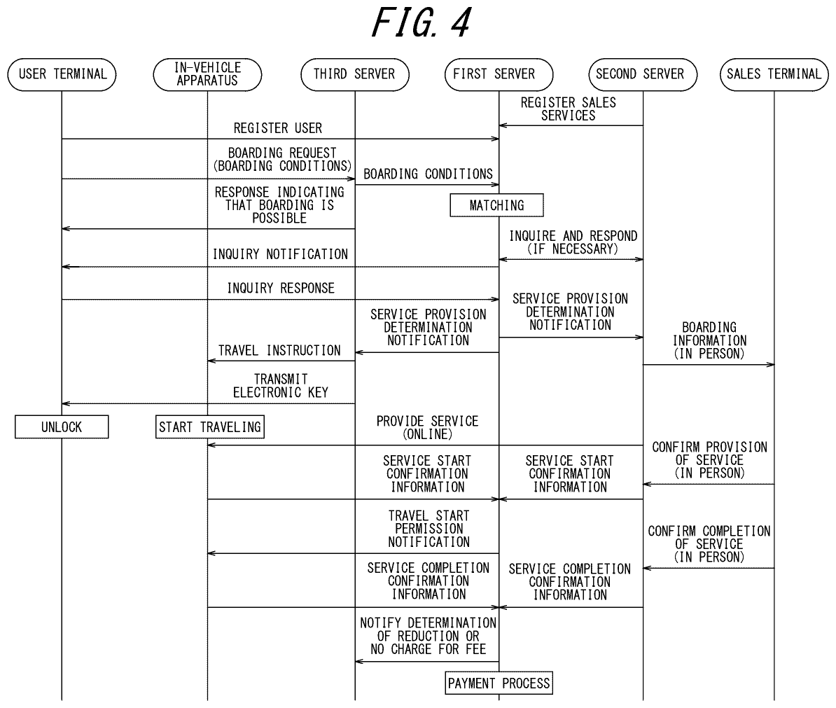

A procedure for providing a sales service to a user will be described below with reference to FIG. 4.

First, as conditions before a user requests to use a transportation service, information on a plurality of sales services that can be provided by a sales service provider is registered from the second server 20 to the first server 10. The plurality of sales services that can be provided by the sales service provider correspond to first services. Information on each sales service may include the name of the service, the contents of the service, conditions (hereinafter referred to as “target conditions”) for users to whom the sales service provider suggests to provide the service, time required to provide the service, and compensation for use of the service. The target conditions may include information such as the users' age, gender, place of residence or place of service, time of day, and the users' hobbies and preferences. The target conditions may further include information on priority. The first server 10 stores the service information in the memory 12.

When the system 1 provides sales services to users with membership, the users' attribute information may be registered in advance from the user terminals 40 to the first server 10. The attribute information may include information on each user's age, gender, family, address, hobbies, preferences, and the like. The first server 10 may store the attribute information for each user in the memory 12. When user information is used for matching as described below, the user information should have been acquired at any time prior to such matching. Therefore, it is not mandatory for users to register the user information in advance.

Assume a case in which a user requests to use a transportation service while the service information and the user's attribute information are registered as described above. The user accesses the third server 30 operated by a transportation service provider and transmits a boarding request including boarding conditions. The boarding conditions include information on a departure location, destination location, and/or utilization time of travel desired by the user. The utilization time indicates the length of time the vehicle 5 is being used or the length of time the user is on board the vehicle 5. The boarding conditions may further include a boarding start time (a scheduled time of the user getting on the vehicle 5). The third server 30 may estimate the utilization time from the information on the departure location, destination location, and boarding start time.

The third server 30 transmits the boarding conditions to the first server 10. When there is an available vehicle 5 that meets the boarding conditions desired by the user, the third server 30 may transmits, to the user terminal 40, a response indicating that boarding is possible. The response indicating that boarding is possible may be transmitted together with an inquiry notification or an inquiry response described below.

Upon receiving the boarding conditions for the user, the first server 10 matches the target conditions for each sales service stored in the memory 12 with the boarding conditions and the user's attribute information. The first server 10 selects one or more sales services that can be provided to the user within the utilization time of the transportation service by the user. When priority is set to the target conditions, the first server 10 may preferentially select a service that matches the user's boarding conditions and attribute conditions and the target conditions with the highest priority. When the user's attribute information is not registered in the first server 10, the first server 10 may perform matching within the range of the boarding conditions. The one or more sales services selected by the first server 10 correspond to second services.

Before determining the selection of the one or more sales services, the first server 10 may, if necessary, inquire of the second server 20 whether such sales services can be provided. For example, when the one or more sales services include a service provided face-to-face by a sales representative, as described below, the second server 20 determines whether the sales representative can be assigned to time during which the sales service is scheduled to be provided. The second server 20 responds, to the first server 10, whether the services can be provided according to results of determination. Sales services that cannot be provided are excluded from the one or more sales services to be selected.

Next, the first server 10 transmits information on the selected one or more sales services to the user terminal 40 and inquires whether to accept any of the sales services. This inquiry is referred to as “inquiry notification”. The inquiry notification may include information on the name of the service, the contents of the service, and compensation for receiving the service. The information on the compensation includes, for example, reduction or no charge for a fee for use of the on-demand vehicle. The user terminal 40 may display the received information on the sales services using a display included in the output interface 46. The user terminal 40 may display the selected services in a list format to the user when there is more than one service selected. The user terminal 40 may display only some services with high priority. The inquiry notification may also be transmitted to the user terminal as an e-mail or voice call.

The user who has received the inquiry notification responds to the inquiry notification. In the following, assume a case in which the user responds to use a sales service. The sales service that the user responds to accept, from among the one or more of the sales services, corresponds to a third service. The user may respond to use no sales services, or may choose not to respond. In such cases, the transportation service may be provided by the transportation service provider at a stipulated rate. In FIG. 4, the inquiry notification and the response transmitted and received between the first server and the user terminal 40 may be transmitted and received through the third server 30.

Upon receiving, from the user terminal 40, the response indicating the use of the sales service, the first server 10 notifies the second server 20 and the third server 30 that the provision of the sales service to the user is determined (hereinafter referred to as “service provision determination notification”).

Upon receiving the service provision determination notification, the second server 20 prepares to provide the sales service to the user terminal 40 or the in-vehicle apparatus 50 of the vehicle 5 that the user is on board. When the sales service that is determined to be provided is a face-to-face business meeting by a sales representative, the second server 20 transmits, to the sales terminal 60 in the possession of the sales representative, boarding information including a boarding location and time for boarding the vehicle 5.

Upon receiving the service provision determination notification, the third server 30 transmits a travel instruction to the in-vehicle apparatus 50 of the vehicle 5 so that the user can be picked up at a predetermined time at which the user desires to travel. The travel instruction includes information on a travel route. The travel route may include boarding and alighting locations to allow one or more users to get on and off. The vehicle 5 starts traveling at an appropriate time according to the travel instruction.

When the sales service to be provided to the user includes a face-to-face business meeting by a sales representative, the travel route along which the vehicle 5 travels may include boarding and alighting locations to allow the sales representative to get on and off. To ensure that the sales representative gets on the vehicle 5 at the boarding location, the first server may monitor a route along which the vehicle 5 travels and transmit, to the vehicle 5, an instruction to output an alert when the vehicle 5 deviates from a route heading for the boarding location for the sales representative. When the vehicle 5 stops at the boarding location for the sales representative, the first server 10 may transmit, to the in-vehicle apparatus 50, an instruction to prohibit travel of the vehicle 5 until it is confirmed that the sales representative has got on the vehicle 5 (e.g., ignition is turned off in a parking space). Whether the sales representative has got on the vehicle 5 may be notified from the in-vehicle apparatus 50 to the first server 10 by the sales representative operating the sales terminal 60 or by a camera mounted on the vehicle 5 confirming the boarding of the sales representative by image recognition. As the sales representative gets on the vehicle 5, the first server may transmit, to the in-vehicle apparatus 50, an instruction to permit travel of the vehicle 5. Thus, the sales representative reliably gets on the vehicle 5 to conduct the face-to-face business meeting.

At any time before the user gets on the vehicle 5, the third server 30 may transmit, to the user terminal 40, an electronic key, which is electronic information to unlock the vehicle 5. When the vehicle 5 arrives at the boarding location, the user may unlock the vehicle 5 by transmitting and receiving information on the electronic key to and from the vehicle 5 or the in-vehicle apparatus 50 using a short-range wireless communication function for boarding of the communication interface 43 of the user terminal 40. This increases security by preventing unauthorized use of transportation services. The mechanism for unlocking the vehicle 5 is not limited to this. For example, the in-vehicle apparatus 50 may acquire, via the first server 10, location information on the user terminal 40 acquired by the positioner 44 and open the lock when the acquired location information substantially matches location information of the in-vehicle apparatus 50 itself acquired by the positioner 54.

When the sales service to be provided to the user includes a business meeting by a sales representative and the sales representative is on board the vehicle 5 before the user, the opening and closing of doors of the vehicle 5 may be operated by the sales representative operating the sales terminal 60 when allowing the user to get on. In such a case, the electronic key that can open and close the doors of the vehicle 5 is transmitted in advance from the first server 10 to the sales terminal 60. This electronic key need not have the authority to allow the vehicle 5 to start traveling. By proximity wireless communication between the vehicle 5 and the sales terminal 60, the opening and closing of the doors are permitted within the authority of the electronic key transmitted to the sales terminal 60. The doors that can be opened and closed by the electronic key may be restricted to rear seats only, for example.

When the user gets on the vehicle 5, the provision of the sales service to the user starts. When the sales service is provided online, the user can receive the provision of the sales service using the input interface 55 and output interface 56 of the in-vehicle apparatus 50. For example, the user can respond to a questionnaire displayed on a touch panel, which also serves as the input interface 55 and output interface 56. For example, the user can have a remote business meeting with a sales representative located remotely using a camera and microphone included in the input interface 55 and a display included in the output interface 56. The contents of online sales services may be stored in the memory 12 of the first server 10 in advance and provided by the first server 10. The user may also receive the provision of the sales service through the user terminal 40, instead of the in-vehicle apparatus 50.

When the sales service is provided online, the in-vehicle apparatus 50 and/or the user terminal 40 may recognize a start of the provision of the sales service to the user and transmits that information to the first server 10 as service start confirmation information. For example, the sales services may be provided as an application available from the in-vehicle apparatus 50. Upon detecting a launch of the application, the in-vehicle apparatus 50 may transmit the service start confirmation information to the first server 10. This service start confirmation information is an example of a notification that accompanies a launch of an application. The same is true for the user terminal 40. The service start confirmation information transmitted from the user terminal 40 may be transmitted to the first server 10 via the second server 20 that provides the sales service.

In one embodiment, the vehicle 5 is prohibited from starting traveling (e.g., ignition is not permitted to switch from an off mode to an on mode, or an engine is not permitted to be actuated), i.e. the user on board does not start traveling until the user starts receiving the sales service. The forms of prohibiting travel of the vehicle 5 include the following first and second forms. The first form is one in which, when the vehicle 5 arrives at the boarding location for the user in response to the travel instruction, after the use of the sales service by the user is determined, the vehicle 5 waits in a setting in which travel is prohibited in advance. The second form is one in which, after the vehicle 5 arrives at the boarding location for the user, the first server 10 transmits, to the in-vehicle apparatus 50 of the vehicle 5, an instruction to prohibit a start of travel. In either case, upon recognizing a start of the sales service in response to the receipt of the service start confirmation information, the first server 10 may transmit, to the in-vehicle apparatus 50, a travel start permission notification to allow the vehicle 5 to start traveling. The vehicle 5 may start traveling after boarding of the user only when the in-vehicle apparatus 50 receives the travel start permission notification. The user who has responded to receive the sales service can be thereby encouraged to use the sales service. This function of limiting a start of travel may be optional and may be omitted in other forms.

When the sales service provided to the user is a face-to-face business meeting with a sales representative, the service starts when both the user and the sales representative get on the vehicle 5. The sales representative may operate the sales terminal 60 to transmit, to the second server 20, information confirming that the provision of the sales service is started.

When the online provision of the sales service is completed, the second server 20 and/or the in-vehicle apparatus 50 transmits, to the first server 10, service completion confirmation information indicating that the provision of the sales service is completed. When the sales service is a face-to-face service by a sales representative, the sales representative may operate the sales terminal 60 when the business meeting is completed, to transmit, to the second server 20, information confirming the provision of the sales service is completed. In response, the second server 20 may transmit the service completion confirmation information to the first server 10.

After acquiring the service completion confirmation information, the first server 10 may transmit, to the third server 30 or user terminal 40, information indicating that reduction or no charge for a fee or provision of compensation is determined. The first server 10 also determines the amount of payment among the sales service provider, the transportation service provider, and the user, and notifies a system executing a payment process.

As described above, according to the present embodiment, technology for providing sales services can be improved. The sales service provider is able to expand contact opportunities with users who are not actively acquiring information, by taking advantage of opportunities of travel using the vehicle 5. This enables expansion of sales opportunities for products and marketing to different user communities than before. In addition, the user of the transportation service can receive a benefit such as reduction of a fee related to the transportation service by using spare time to receive the sales service.

In the system 1, various information processing can be shared among the first server 10, second server 20, and third server 30. For example, in the above embodiment, the user terminal 40 transmits a boarding request to the third server 30 and receives, from the third server 30, a response indicating that boarding is possible. However, the user terminal 40 and the third server may be configured to exchange these information via the first server 10. In such a case, the third server 30 need not transmit boarding conditions to the first server 10.

(Processes Executed by First Server 10)

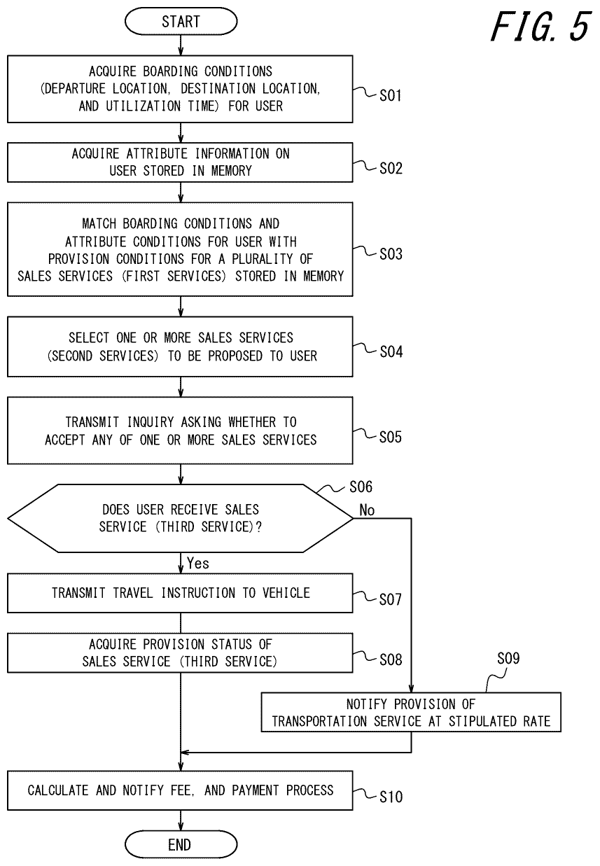

An information processing method executed by the controller 11 of the first server 10 according to the present embodiment will be described with reference to a flowchart in FIG. 5.

First, the controller 11 acquires, from the third server 30, boarding conditions (a departure location, destination location, and a utilization time) for a user who requests to use a transportation service (step S01).

The controller 11 acquires attribute information on the user stored in the memory 12 (Step S02).

The controller 11 matches the user's boarding conditions and attribute conditions with provision conditions for a plurality of sales services (first services) stored in the memory 12 (step S03).

Based on a matching result of step S03, the controller 11 selects one or more sales services (second services) to be proposed to the user (step S04).

The controller 11 transmits, via the communication interface 13 to the user terminal 40, an inquiry asking whether to accept any of the one or more sales services (step S05).

Upon receiving a response to the inquiry from the user terminal 40, the controller 11 proceeds to step S07 when the user receives any sales service (third service) (Yes in step S06).

The controller 11 transmits a travel instruction to the vehicle 5 at an appropriate time (step S07). At this time, the controller 11 may transmit, to the user terminal 40, an electronic key to allow the user to get on the vehicle 5.

The controller 11 acquires a service provision status including a start and end of provision of the online or in-person sales service (third service) (step S08).

When the user does not receive any sales service in step S06 (No in step S06), the controller 11 notifies the user terminal 40 that the transportation service is provided at a stipulated rate (step S09).

After steps S08 and S09, the controller 11 calculates a fee and notifies a system that performs a payment process (step S10).

(Another Procedure for Providing Sales Service)

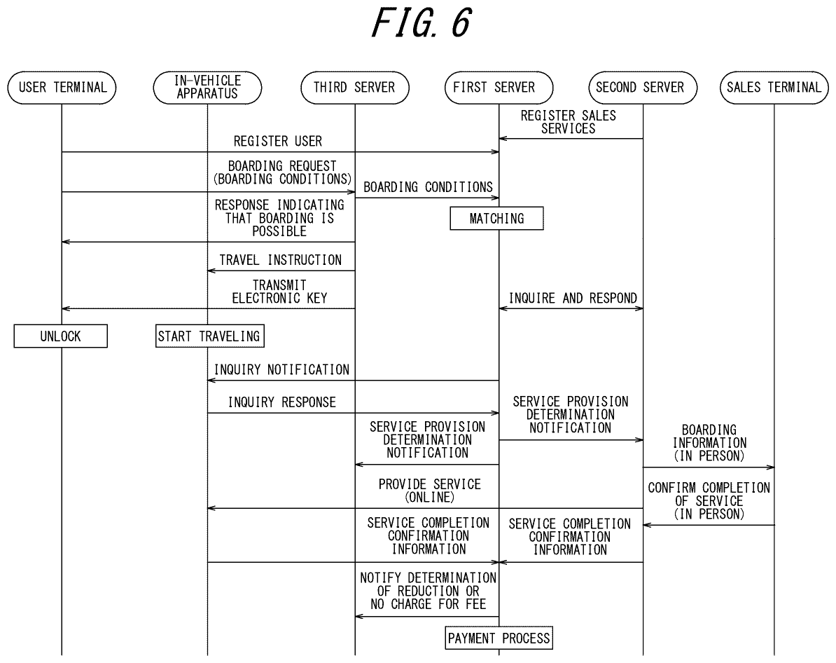

Another procedure for providing a sales service, which differs from the procedure described using FIG. 4, will be described with reference to FIG. 6. FIG. 6 shares many points with FIG. 4, so a difference from FIG. 4 will be described.

In the procedure illustrated in FIG. 6, after the matching of a user's boarding conditions and attribute information with sales services is executed, the first server 10 does not transmit, to the user, an inquiry notification asking whether to use a sales service, before the user gets on the vehicle 5. After the user gets on the vehicle 5, the first server 10 may transmit an inquiry notification asking whether to use a sales service to the in-vehicle apparatus of the vehicle 5. Therefore, a start of a sales service is not a condition for the vehicle 5 to start traveling. In this case, after the matching, the first server asks the second server 20 whether to provide selected sales services to the user, and requests a response before a start of travel. The sales service provider should respond to this by a time at which the user starts traveling.

In this way, the sales service provider can provide the sales services needed at the time of providing the services. Furthermore, since the user receives an inquiry as to use of the sales services for the first time at the point of starting traveling, it can be expected that the user is more likely to receive a sales service, unless the user has a plan to do anything else during time of travel at that point. Thus, the sales service provider is more likely to be able to offer the sales services.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined into one or divided.

For example, in the above embodiment, the transportation service provider shall provide on-demand vehicle transportation services. The transportation service provider may be a service provider that creates travel plans for users who travel using autonomous private vehicles. In such a case, the first server may be configured to provide a sales service for travel time registered in a travel plan created by a user.

1. An information processing method performed by a server, the information processing method comprising:
acquiring a boarding condition for a user who uses a vehicle as transportation, the boarding condition including a departure location, a destination location, and/or a utilization time of travel using the vehicle;
selecting one or more second services meeting the boarding condition from among a plurality of first services, the plurality of first services being services related to sales and/or marketing capable of being provided in the vehicle during the travel; and
outputting an inquiry notification including information regarding the second services to an in-vehicle apparatus of the vehicle and/or a terminal of the user, in order to allow the user to respond whether to accept provision of at least any one of the selected second services when the user uses the vehicle under the boarding condition.

2. The information processing method according to claim 1, comprising:
receiving, by the server from the in-vehicle apparatus and/or the terminal of the user, a response of the user accepting a third service included in the second services; and
upon receiving information indicating that the user has finished receiving the third service during use of the vehicle, performing, by the server, a process to provide the user with reduction or no charge for a fee related to the travel or with compensation.

3. The information processing method according to claim 1, wherein
the vehicle is configured to prohibit a start of the travel until the user starts receiving a third service, and
the server is configured to, upon receiving, from the in-vehicle apparatus and/or the terminal of the user, a response of the user accepting the third service included in the second services, provide the vehicle with an instruction to permit the start of the travel, after recognizing that the user has started receiving the third service.

4. The information processing method according to claim 3, comprising, when the third service is provided as an application used from the in-vehicle apparatus or the terminal of the user, recognizing, by the server, that the user has started receiving the third service upon receiving, from the in-vehicle apparatus or the terminal of the user, a notification accompanying a launch of the application.

5. The information processing method according to claim 1, comprising:
receiving, by the server from the in-vehicle apparatus and/or the terminal of the user, a response of the user accepting a third service included in the second services; and
when the third service includes a face-to-face service provided to the user by a sales representative who conducts sales to the user, transmitting, by the server to the vehicle, information on a travel route including a route allowing the sales representative to get on board.

6. The information processing method according to claim 1, comprising outputting, by the server, the inquiry notification after the user gets on the vehicle.
